(19) United States
(12) Patent Application Publication
(10) Pub. No.: US 2008/0081233 A1
(43) Pub. Date: Apr. 3, 2008

(54) Energy generation unit comprising at least one high temperature fuel cell

(76) Inventors: Juergen Rechberger, Graz (AT); Martin Schuessler, Graz (AT); Peter Prenninger, Graz (AT)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 11/902,955

(22) Filed: Sep. 26, 2007

(30) Foreign Application Priority Data
Oct. 3, 2006 (AT) A 1655/2006

(51) Int. Cl. H01M 8/06

(52) U.S. Cl. 429/20

(57) ABSTRACT

The invention relates to an energy generation unit comprising at least one high-temperature fuel cell, which is preceded by a reformer for preprocessing the fuel for the high-temperature fuel cell, having an outgoing line at the cathode side, which transfers thermal energy to the reformer. The reformer is placed in a preferably cylindrical combustion chamber of a flame burner, which flame burner is activated during the start-up phase of the energy generation unit, and the combustion chamber of the flame burner is connected to the outgoing line at the cathode side of the high-temperature fuel cell in order to subject the reformer to cathode exhaust gas from the fuel cell.

### BACKGROUND OF THE INVENTION

The invention relates to an energy generation unit comprising at least one high-temperature fuel cell, which is preceded by a reformer for preprocessing the fuel for the high-temperature fuel cell, having an outgoing line at the cathode side, which transfers thermal energy to the reformer.

Energy generation units of this kind may for instance be used in automotive vehicles as power train support units (PTSU) for supplying electrical or thermal energy. Such systems may also be used for heating driver compartments or for exhaust treatment in internal combustion engines.

### DESCRIPTION OF PRIOR ART

From WO 2005/005027 A1, for instance, there is known a high-temperature fuel cell associated with an internal combustion engine, which operates on the liquid fuel of the combustion engine. According to an embodiment shown in FIG. 3 the high-temperature fuel cell is preceded by a reformer and possibly by a desulphurization device. The anode effluent is used in the exhaust treatment of the internal combustion engine and is fed into a high-temperature and a low-temperature catalytic converter via metering valves, which are controlled by the electronic motor management unit. It is also possible to divert a partial stream of the reformate produced by the reformer before the fuel cell and add it to the anode effluent via a mixing valve, thus achieving an optimum composition of the flow of reducing agent used in the exhaust treatment of the internal combustion engine. The electrical energy generated by the fuel cell may be used for heating the catalytic converter of the exhaust treatment system of the internal combustion engine.

U.S. Pat. No. 5,208,114 A describes an energy generation unit using a high-temperature fuel cell (MCFC). The anode of the fuel cell is preceded by a reformer, in which the fuel (natural gas) for the fuel cell is preprocessed. The outgoing line on the cathode side is provided with a branch leading to a heater chamber of the reformer, into which is fed the hot cathode exhaust gas. According to a variant (e.g., FIG. 8 or 9), a recycling line branches off at the output port of the anode of the fuel cell, which opens into the feeder line of the reformer after passing a blower and a heater unit, thus setting the reformer temperature.

From DE 101 55 193 A1 a fuel cell system is known, which comprises a low-temperature fuel cell, a so-called PEM fuel cell, and a reformer placed before the anode side for preprocessing the gaseous fuel. The reformer is located in a combustion chamber of a gas burner into which is fed the anode exhaust gas via an anode residual gas line. The exhaust of the gas burner is connected to the feeder line of the fuel cell on the cathode side, the gas burner thus flow-preceding the fuel cell.

### SUMMARY OF THE INVENTION

It is the object of the present invention to give a compact and energy-efficient design of an energy generation unit with at least one high-temperature fuel cell, which will above all ensure rapid cold-start.

In the invention this object is achieved by providing that the reformer is placed in the preferably cylindrical combustion chamber of a flame burner, the flame burner being activated during the start-up phase of the energy generation unit, and that the combustion chamber of the flame burner is connected to the outgoing line of the high-temperature fuel cell on the cathode side, to supply the reformer with the cathode exhaust gas of the fuel cell. The preferably centered placement of the fuel reformer in a flame burner will permit rapid start-up. Following the starting phase the combustion chamber of the flame burner is used for additionally required heating tasks (e.g., compartment heating). Heat exchange between the media in the heating chamber and in the reformer is negligible during operation since no temperature gradient exists. By exposing the wall of the reformer to hot gas it is heated and an ideal homogeneous temperature distribution is set up in the reformer, which will ensure efficient soot-free reforming.

According to a further development of the invention the flame burner is provided with an annular chamber surrounding the combustion chamber, with the combustion chamber having transition openings into the annular chamber on the side facing the high-temperature fuel cell and with a helical heat exchanger being located in the annular chamber, which supplies an oxidating agent, preferably air, to the cathode side. In a compact assembly the air fed to the high-temperature fuel cell is thus heated by heat exchange with the cathode exhaust gas.

In further optimization of the invention the helical heat exchanger is preceded by a plate heat exchanger through which will pass the feeder line of the oxidating agent connected to the helical heat exchanger, the feeder line for the reformer and the outgoing line from the cathode. The advantages arising from serializing the plate and the helical heat exchanger will be further described in connection with the individual embodiments.

A compact design and minimization of the thermal mass will be achieved by placing the high-temperature fuel cell, the flame burner with the helical heat exchanger and the plate heat exchanger one behind the other in compact arrangement and by encasing them in a common external insulating cover.

According to the invention the energy generation unit may also be provided with a clamping structure which is external to the insulating cover and clamps the components of the unit sealingly together.

### BRIEF DESCRIPTION OF THE DRAWINGS

The invention will be further described below, with reference to the enclosed drawings. There is shown in

FIG. 1 a first variant of an energy generation unit according to the invention in a longitudinal section; and in

FIG. 2 a second variant of an energy generation unit according to the invention, again in longitudinal section.

### DETAILED DESCRIPTION OF THE PREFERRED EMBODIMENTS

The assembly subsequently described is a highly integrated high-temperature fuel cell system. The fuel cell, for instance a molten carbonate fuel cell (MCFC) or a solid oxide fuel cell (SOFC) uses a liquid hydrocarbon fuel (e.g., diesel oil).

A fuel cell is essentially composed of a number of individual cells, each consisting of anode, elctrolyte and cathode, where the anode has to be supplied with the fuel and the cathode with an oxidating agent (e.g., air). The term “high-temperature fuel cell” will also extend to an assembly of a plurality of individual cells forming a fuel cell stack.

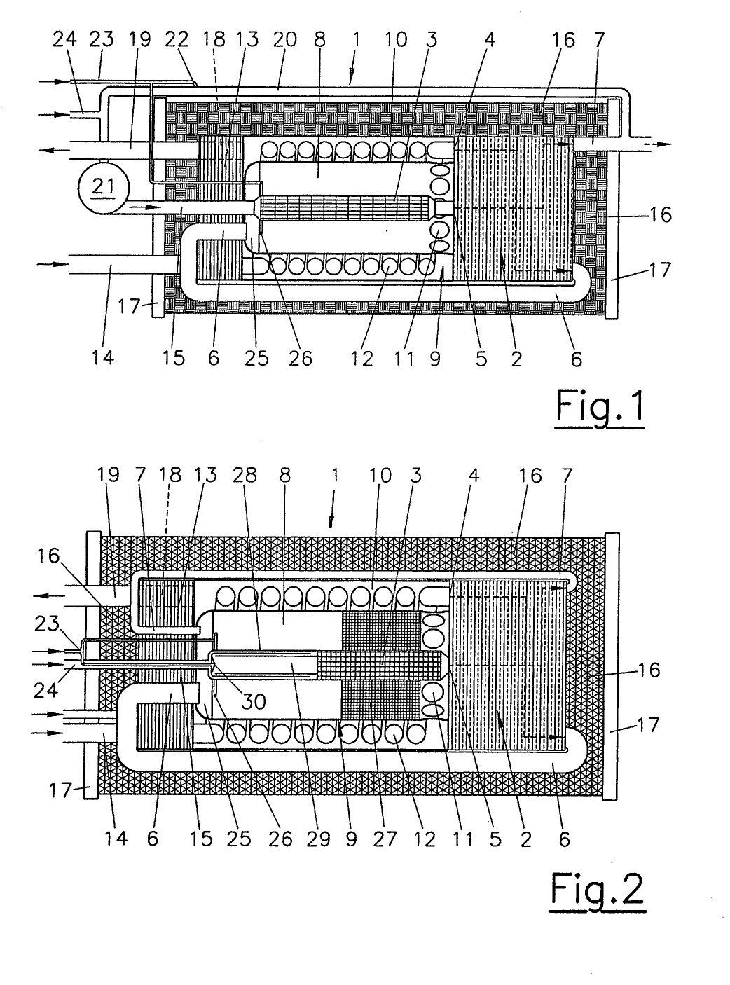

The energy generation unit 1 shown in FIG. 1 has at least one high-temperature fuel cell 2 (or a fuel cell stack), which is preceded by a reformer 3 for preprocessing the fuel (e.g., natural gas or diesel oil) of the high-temperature fuel cell 2. The high-temperature fuel cell 2 has a port 4 at the cathode side, a port 5 at the anode side, an outgoing line 6 at the cathode side for the cathode exhaust gas and an outgoing line 7 at the anode side for the anode exhaust gas, the flow paths within the high-temperature fuel cell being only schematically indicated.

The reformer 3 is placed in a preferably cylindrical combustion chamber 8 of a flame burner 9, which can be activated during the start-up phase of the energy generation unit 1. The combustion chamber 8 of the flame burner 9 is further connected to the outgoing line 6 on the cathode side of the fuel cell in such a way that the reformer 3 may be subjected to the cathode exhaust gas of the high-temperature fuel cell 2. The flame burner 9 has an annular chamber 10 enclosing the combustion chamber 8, the combustion chamber 8 having transition openings 11 into the annular chamber 10 at the end next to the high-temperature fuel cell 2. A helical heat exchanger 12 is located in the annular chamber 10, which supplies air to the cathode side of the high-temperature fuel cell 2.

As is further shown in FIG. 1 the helical heat exchanger 12 is directly preceded by a plate heat exchanger 13, which transfers heat from the hot cathode exhaust gas entering the plate heat exchanger 13 from the outer annular chamber 10 and leaving the system via the outgoing line 19, to the cold oxidating agent (preferably air) entering via the feed line 14.

The plate heat exchanger 13 is either of semicircular or annular shape, since the outgoing line 6 of the cathode and the feeder line 15 for the reformer 3 must pass through the heat exchanger without partaking in the heat exchange.

In all variants the high-temperature fuel cell 2, the flame burner 9 with helical heat exchanger 12 and the plate heat exchanger 13 are compactly placed one behind the other and encased by a common external insulating cover 16. The energy generation unit 1 is provided with a clamping structure (only the clamping plates 17 at the ends are shown in the drawing), which is located outside the insulating cover 16 and sealingly clamps together the individual components 2, 9, 13 of the unit.

During steady-state operation of the energy generation unit 1 the system is supplied with filtered, slightly pressurized ambient air via line 14. In vehicle applications the air pump (not shown) may advantageously be placed next to the air filter of the vehicle. Since the air has to be preheated prior to entering the high-temperature fuel cell, a combined heat exchanger is provided. Heat exchange first occurs in the plate heat exchanger 13, which is followed by the helical heat exchanger 12. The preheated air (500-700° C.) then flows past the cathode of the fuel cell 2. Part of the oxygen diffuses as oxygen ions via the electrolyte to the anode, the remaining part of the supplied air absorbs the waste heat of the electrochemical reaction and thus cools the fuel cell 2. The oxygen depleted air flows via the outgoing line 6 of the cathode side within the insulating cover 16 into the combustion chamber 8 of the flame burner 9. During steady-state operation of the fuel cell the gas flows through the burner 9 without reacting and via the openings 11 into the outer annular chamber 10 where heat exchange with the cold air occurs in the helical heat exchanger. Via an opening 18 in the plate heat exchanger 13 the cathode exhaust gas is collected and again transfers heat to the entering cold air in the heat exchanger 13. The cathode exhaust gas finally leaves the system via line 19.

The embodiment shown in FIG. 1 has a recirculation line 20 for the anode exhaust gas, which departing from the outgoing line 7 for the anode exhaust gas leads to the feeder line 15 of the reformer 3, and where upstream of a compressor 21 preceding the reformer 3 an injector 22 is provided for spraying or injecting liquid fuel into the hot anode exhaust gas. Liquid fuel is fed into the system via a pump (not shown) and via the fuel feeder line 23. Anode exhaust gas of the fuel cell 2 is drawn through the recirculation line 20 and the compressor 21. This gas mixture consists essentially of N₂, CO₂, H₂O and residual amounts of H₂, CO and CH₄, and is a perfectly suitable carrier medium in which liquid diesel oil may be completely evaporated. After diesel oil has been sprayed into this gas mixture by the injector 22 the temperature drops from approximately 600° C. to 350° C. due to the evaporation enthalpy of diesel oil. Since the reforming process requires an oxidating agent, air must be metered to the gas mixture via a line 24. This air is not preheated and thus the temperature of the gas mixture further decreases to approximately 250° C. The entry temperature of the gas into the compressor 21 is thus in a temperature range which permits the use of conventionally available compressors (conventional positive displacement or rotary pumps). The gas mixture is homogenized optimally (depending on the working principle of the compressor) and leaves the compressor via the feeder line 15. In the following catalytic reformer 3 the long-chain hydrocarbons are broken and reformed to H₂, CO and residues of CₓH_{y}. This gas mixture can now be fed directly as fuel to the fuel cell 2. In the fuel cell H₂ reacts with the oxygen ions coming from the anode by giving off electrons and heat. The reaction thus generates water, which together with nitrogen and fuel residues leaves the high-temperature fuel cell via the outgoing line 7. Part of this exhaust gas is fed back into the system via the recirculation line 20, as described above.

The energy generation unit 1 is enclosed in a high-temperature resistant insulating cover 16. The two clamping plates 17 apply the clamping force necessary during operation of the fuel cell, the clamping principle being derived from AT 413.009 B and now extended to all hot parts of the system. The pumping devices and metering elements of the energy generation unit 1, for the most part not shown, are placed outside the insulating cover 16 in an area cooled by fresh air.

The variant shown in FIG. 1 has a connecting interface to an exhaust treatment device if used in a vehicle with an internal combustion engine. The anode exhaust gas exiting from the outgoing line on the anode side may be used in a known way for exhaust treatment of the internal combustion engine.

The energy generation unit of the invention may be started up in a very efficient and simple manner. Cold filtered air is fed into the system via the supply unit and the feeder line 14. The air flows through the two heat exchangers 12, 13 and the high-temperature fuel cell 2 into a distribution chamber 25 of the combustion chamber 8. There the air is distributed uniformly over the cross-section of the burner and fed into the combustion chamber through bores. Liquid fuel is supplied to the flame burner 9 via the fuel feeder line 23 and is distributed by an annular line 26. An electrical ignition device (not shown) ignites the liquid fuel and a flame is stabilized. The air, which now is hot, flows through the transition openings 11 into the outer annular chamber 10 and by means of the helical heat exchanger 12 and the plate heat exchanger 13 transfers heat to the air flowing into the system. In this way the fuel cell can be brought to operating temperature in a controlled way via a simple control loop. The control variable is the amount of fuel. The air mass flow results from a defined fuel/air ratio. Due to the thermal coupling of combustion chamber 8 and catalytic reformer 3 the latter can very rapidly be brought up to operating temperature. The anode circuit can now start to operate and a reducing atmosphere can be established at the anode. This is important in order to avoid nickel oxidation of the anode catalyst at higher temperatures.

The second embodiment of the invention shown in FIG. 2 is to a lesser degree integrated into a vehicle system. There is no interface to an exhaust treatment device. The high-temperature fuel cell 2 has an outgoing line 7 on the anode side, which leads within the exterior insulating cover 16 through the plate heat exchanger 13 into the combustion chamber 8 of the flame burner 9, an oxidation catalyst 27 surrounding the reformer 3 being provided in the combustion chamber 8. The unused fuel components in the anode exhaust gas are brought together with the cathode exhaust gas in the chamber 25 and are oxidized in the oxidation catalyst 27. The gaseous products of the catalytic reaction enter the annular chamber 10 through the openings 11 and leave the system via the spaces indicated by 18 in the plate heat exchanger 13 and via the connecting line 19.

The reformer 3 placed in the combustion chamber 8 of the flame burner 9 has a pipe-shaped (pipe within pipe) heat exchanger 28 for preheating the oxidizing agent, preferably air, needed for the reforming process. The pipe-shaped heat exchanger 28 comprises a mixing chamber 29, in which an injector element 30 for the liquid fuel is located. The liquid fuel is injected into the preheated air in the mixing chamber 29 and evaporates completely.

The invention is characterized by the following advantageous features:
Very compact, simple and light design;
The burner function of the energy generation unit can be operated independently of the fuel cell, i.e., within the limits given by the design a desired amount of thermal energy can be supplied rapidly at any time;
Due to the highly integrated system and the small amount of mass to be heated very fast start-up of the system is possible;
Operation of the anode circuit can be started quickly since the catalyst of the reformer is preheated by the burner;
Dynamic delivery of reformate gas for exhaust treatment is possible (see variant FIG. 1);
During shut-down the compressor in the anode circuit permits cooling-off under a reducing environment (no nickel oxidation) (see variant FIG. 1);
By boxing-in and integration the thermal mass of the system can be minimized;
The free surface towards the environment is minimal→heat losses are reduced;
By arranging plate and helical heat exchanger in series the maximum temperature difference for each heat exchanger may be reduced from 800° C. to 400° C.→a significant reduction of the probability of tension cracks and a lengthened service life of the heat exchangers will follow (in addition there is very little pressure loss in the helical heat exchanger);
Gases and fuel are fed from a side which is cold due to flushing of the housing→uncontrolled premature evaporation of fuel is avoided, gases are controlled in the cold state;
An electrical ignition device permits operation of the flame burner independently of the fuel cell→start-up at very low temperatures is possible;
Due to the centered placement of the fuel reformer in the combustion chamber it can be brought up to operating temperature in a very short time after the start of the burner. The whole system may thus be heated quickly and efficiently by the burner;
The fuel reformer can produce reformate gas very quickly and can thus provide a reducing environment for the anode of the fuel cell→nickel oxidation is avoided;
By the clamping structure placed outside of the insulating cover the clamping force needed for the operation of the fuel cell can be supplied without problems;
All valves and pumping devices are situated in an area outside the insulating cover, which is flushed with ambient air, and are thus not subject to thermal loads;
For mixing and processing of fuel, air and anode exhaust gas sufficient space and heat is provided, thus optimum homogenization and fuel evaporation, as required for soot-free and efficient reforming, will be ensured;
Via the anode circuit the anode can be kept permanently under a reducing atmosphere during the cooling-off phase of the fuel cell→nickel oxidation is avoided (see variant FIG. 1);
Due to large flow cross-sections pressure losses in the system can be substantially reduced→system efficiency is increased due to reduction of the necessary compressor power;
Since the parts used are very simple (pipes, shells, plates) and no costly manufacturing technologies are needed, mass production will be possible at very low cost;
The flame burner is downstream of the fuel cell in flow direction, i.e., during heating-up of the system the exhaust gases of the burner do not pass through the fuel cell, the stack is exclusively supplied with thermal energy by means of a heat exchanger.

What is claimed is:

1. An energy generation unit comprising at least one high-temperature fuel cell, which is preceded by a reformer for preprocessing the fuel for the high-temperature fuel cell, having an outgoing line at the cathode side, which transfers thermal energy to the reformer, wherein the reformer is placed in a combustion chamber of a flame burner, which flame burner is activated during the start-up phase of the energy generation unit, and wherein the combustion chamber of the flame burner is connected to the outgoing line at the cathode side of the high-temperature fuel cell in order to subject the reformer to cathode exhaust gas from the fuel cell.

2. An energy generation unit according to claim 1, wherein the combustion chamber of the flame burner is surrounded by an annular chamber, the combustion chamber being provided at its end facing the high-temperature fuel cell with transition openings into the annular chamber, and wherein a helical heat exchanger is located in the annular chamber, which is used to supply an oxidating agent to the cathode side of the fuel cell.

3. An energy generation unit according to claim 2, wherein the helical heat exchanger is preceded by a plate heat exchanger, through which passes at least one feeder line for the oxidating agent, which is connected to the helical heat exchanger, a feeder line for the reformer and the outgoing line from the cathode side.

4. An energy generation unit according to claim 3, wherein the high-temperature fuel cell, the flame burner with the helical heat exchanger and the plate heat exchanger are compactly built in serial configuration and are enclosed in a common outer insulating cover.

5. An energy generation unit according to claim 4, wherein the energy generation unit is provided with a clamping structure which is located outside of the outer insulating cover and sealingly clamps together the fuel cell, the flame burner and the plate heat exchanger.

6. An energy generation unit according to claim 1, wherein a recirculation line for the anode exhaust gas is provided, which—departing from an outgoing line for the anode exhaust gas—leads to a feeder line of the reformer, wherein an injector is located upstream of a compressor preceding the reformer, which injector serves for spraying or injecting liquid fuel into the hot anode exhaust gas.

7. An energy generation unit according to claim 1, wherein the high-temperature fuel cell has an outgoing line on the anode side, which leads to the combustion chamber of the flame burner, and wherein an oxidation catalyst enclosing the reformer is located in the combustion chamber.

8. An energy generation unit according to claim 7, wherein the reformer being situated in the combustion chamber of the flame burner comprises a pipe-shaped heat exchanger for preheating the oxidating agent needed for the reforming process.

9. Energy generation unit (1) according to claim 8, wherein the pipe-shaped heat exchanger has a mixing chamber containing an injector element for the liquid fuel.
